(19) United States
(12) Patent Application Publication
(10) Pub. No.: US 2008/0270182 A1
(43) Pub. Date: Oct. 30, 2008

(54) METHOD FOR ACHIEVING OUTCOME OBJECTIVES ACROSS CLINICAL SETTINGS

(75) Inventor: Timothy P. Lowney, N. Falmouth, MA (US)

Correspondence Address: PEPPER HAMILTON LLP, ONE MELLON CENTER, 50TH FLOOR, 500 GRANT STREET, PITTSBURGH, PA, 15219, US

(73) Assignee: GERIATRIC HEALTH SERVICES, INC., Canton, MA (US)

(21) Appl. No.: 12/109,114

(22) Filed: Apr. 24, 2008

Related U.S. Application Data
(60) Provisional application No. 60/925,980, filed on Apr. 24, 2007.

(51) Int. Cl. G06Q 50/00

(52) U.S. Cl. 705/2

(57) ABSTRACT

A method of achieving outcome objectives across a clinical setting includes receiving a diagnosis for a patient, receiving one or more goals, each goal having a goal actual rating, a goal expected rating and a goal expected time period, receiving one or more interventions, each intervention having an intervention actual rating, an intervention expected rating and an intervention expected time period, determining a goal variance for each goal, determining an intervention variance for each intervention, and creating a report based on the goal variance and the intervention variance.

### RELATED APPLICATIONS AND CLAIM OF PRIORITY

This patent application claims priority to U.S. Provisional Application Ser. No. 60/925,980, filed Apr. 24, 2007 and entitled, “Method for Achieving Outcome Objectives Across Clinical Settings,” which is hereby incorporated by reference in its entirety.

Not Applicable

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office file or records, but otherwise reserves all copyright rights whatsoever.

### BACKGROUND

The delivery system for health care in the United States over the past generation has evolved into a series of acute and post acute care clinical settings. The acute care setting consists of acute hospitals, i.e., tertiary and community hospitals. The post-acute setting consists of rehabilitation hospitals, skilled nursing facilities, home care organizations, as well as hospitals and private outpatient facilities. Although these clinical settings have existed for generations, their role in the participation of the cycle of care surrounding an acute clinical event has been more clearly defied.

The chief architect defining the role of each setting in the last twenty years has been Medicare. Medicare, beginning with acute settings, changed the way they pay for care from cost reimbursement to DRG and later for the post acute setting to PPS. DRG (Diagnosis Related Group) and PPS (Prospective Payment System) essentially gave providers in all settings a fixed payment (with some flexibility) for the provision of health care appropriate to the setting. This caused significant changes in the type and amount of care rendered in each setting with the incentive to provide only those services necessary to produce clinical improvement required to move the patient to the next, more appropriate, and usually lower cost clinical setting.

The system change also affected the role of Medicare. Medicare, as the payor, no longer focuses on medical necessities of procedures or length of stay in a facility but now is concerned with the quality of care and clinical outcomes. Unfortunately, through all this change, the data to measure quality and outcomes has not evolved. The health care system very much relies on billing data for quality and outcome measures, which is both inaccurate and dated. The surviving clinical document at the bedside (i.e., the SOAP note) does not answer the need for documentation required to predict and measure attainment of goals at each clinical setting that allow clinical and administrative decision makers to discharge the patient to the next appropriate setting in a timely manner. Current clinical documentation at the bedside also does not consider the critical role the patient has in understanding and complying with a plan of care for their disease. Lastly, as the population ages there will be a need to care for complex multi-diagnosed geriatric patients, this will require good retrospective data on which to base complex prospective clinical decisions.

### SUMMARY

In general, in an aspect, the invention is directed to a method of achieving outcome objectives across a clinical setting. The invention includes receiving a diagnosis for a patient, receiving one or more goals, wherein each goal has a goal actual rating, a goal expected rating and a goal expected time period, receiving one or more interventions, wherein each intervention has an intervention actual rating, an intervention expected rating and an intervention expected time period, determining a goal variance for each goal, determining an intervention variance for each intervention, and creating a report based on the goal variance and the intervention variance.

Aspects of the invention may include one or more of the following features. The report can comprise each goal variance exceeding a predetermined threshold. The predetermined threshold can be zero. The report can comprise each intervention variance exceeding a predetermined threshold. The report can categorize the one or more goals into disease-directed goals and patient-directed goals. The step of determining the goal variance can comprise subtracting the goal expected rating from the goal actual rating. The step of determining the intervention variance can comprise subtracting the intervention expected rating from the intervention actual rating. The method may include receiving demographic information for the patient. The method may include determining the goal expected rating based on prior data. The method may include determining the goal expected time period based on prior data. Receiving the one or more goals can comprise receiving disease management goals, wherein each disease management goal comprises an actual disease management severity rating and an expected disease management severity rating. Receiving one or more goals can comprise receiving one or more patient management goals, wherein each patient management goal comprises an actual patient management functionality rating and an expected patient management functionality rating. Receiving one or more interventions can comprise receiving one or more disease management interventions, wherein each disease management intervention comprises an actual disease management intervention efficiency rating and an expected disease management intervention efficiency rating. Receiving one or more interventions can comprise receiving one or more patient management interventions, wherein each patient management intervention comprises an actual patient management intervention efficiency rating and an expected patient management intervention efficiency rating.

The GIVE (“Goals, Intervention, Variances, Expectations”) analysis presents a new format for documentation and communication in health care at the bedside. GIVE, as presented, is geared for the homecare patient setting but can have parameters adjusted for most clinical settings. GIVE analysis uses current medical terminology and familiar rating scales to provide clarity in clinical terms concerning the patient's current or actual medical status. This information is then used to predict a patient's response to therapy and how long it will take for the patient to reach a desired clinical response. The variance between the actual and expected response to therapy is quantifiable. The reason for the variance is something that the clinician must analyze as either a disease management issue or a patient management issue and change goals or interventions based on the analysis of concrete clinical data.

The GIVE analysis focuses on disease severity, patient functionality, and intervention efficacy. The system is geared for a clinical team including physician, nurse practitioner, nurse, physical therapist, occupational therapist, speech therapist, social worker, and most importantly, the patient. GIVE allows for clarity in the communication among team members at any moment in time. The attention of the clinicians is focused on those diagnoses that have a variance greater than zero. These diagnoses have goals that have not been met and the interventions applied to reach these goals are not completely effective. The explanation for the variance must be meaningful and measurable so that a possible solution can be proposed and discussed. If the variance remains unchanged for a prolonged period of time, the responsible clinician must defend the feasibility of a change in the variance in a reasonable time for that particular diagnosis. If it is deemed that the patient is unable to reach a certain predicted goal (i.e. the expectation was too high), the expected outcome rating is changed to reflect that decision along with the reason for the change.

### BRIEF DESCRIPTION OF THE DRAWINGS

Aspects, features, benefits and advantages of the embodiments described herein will be apparent with regard to the following description, appended claims, and accompanying drawings where:

FIG. 1 depicts a block diagram of exemplary internal hardware that may be used to contain or implement program instructions according to an embodiment.

FIG. 2 discloses an overview of the GIVE analysis according to an embodiment.

FIG. 3 depicts a detailed exemplary flowchart of the GIVE analysis according to an embodiment.

FIG. 4 depicts an en exemplary screen displaying the patient information according to an embodiment.

FIG. 5 discloses a chart illustrating the patient's goals and interventions according to an embodiment.

FIG. 6 depicts an illustration of setting up a report according to an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

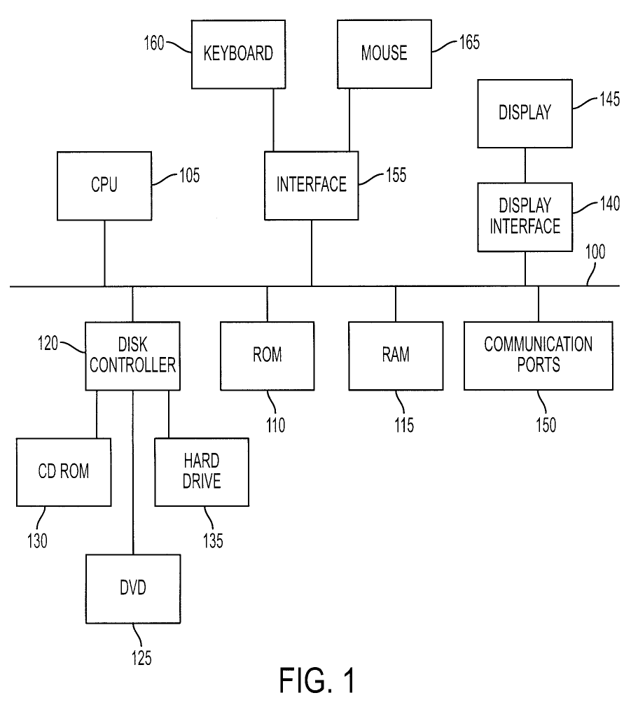

FIG. 1 depicts a block diagram of exemplary internal hardware that may be used to contain or implement program instructions according to an embodiment. Referring to FIG. 1, a bus 100 serves as the main information highway interconnecting the other illustrated components of the hardware. CPU 105 is the central processing unit of the system, performing calculations and logic operations required to execute a program. Read only memory (ROM) 110 and random access memory (RAM) 115 constitute exemplary memory devices.

A disk controller 120 interfaces with one or more optional disk drives to the system bus 100. These disk drives may include, for example, external or internal DVD drives 125, CD ROM drives 130 or hard drives 135. As indicated previously, these various disk drives and disk controllers are optional devices.

Program instructions may be stored in the ROM 110 and/or the RAM 115. Optionally, program instructions may be stored on a computer readable medium such as a compact disk or a digital disk or other recording medium, a communications signal or a carrier wave.

An optional display interface 140 may permit information from the bus 100 to be displayed on the display 145 in audio, graphic or alphanumeric format. Communication with external devices may occur using various communication ports 150. An exemplary communication port 150 may be attached to a communications network, such as the Internet or an intranet.

In addition to the standard computer-type components, the hardware may also include an interface 155 which allows for receipt of data from input devices such as a keyboard 160 or other input device 165 such as a mouse, remote control, pointer and/or joystick.

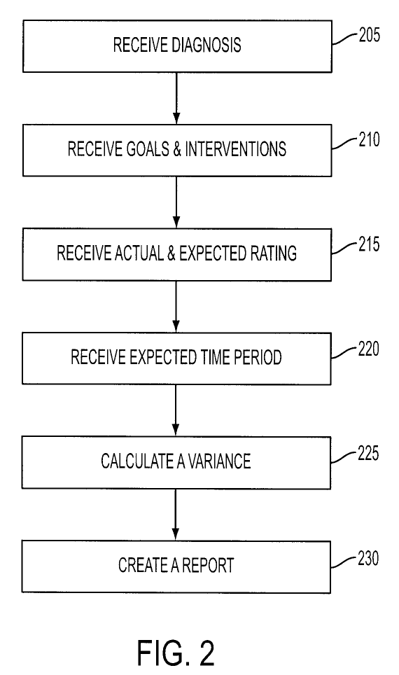

FIGS. 2-6 are diagrams providing more detail on the processes, which the system described above, or other systems, can carry out. FIG. 2 discloses an overview of the GIVE analysis according to an embodiment. The GIVE analysis may be used at a clinical center. A clinical center may include, but is not limited to, a hospital or a rehabilitation center, an outpatient facility and a nursing home. A patient at a clinical center may have one or more diseases. Based on the disease, one or more diagnoses may be received for each patient 205.

The goals and interventions may be divided into disease-directed and patient-directed categories. For each diagnosis, one or more diseases-directed goals and interventions and one or more patient-directed goals and interventions may be received 210.

In an embodiment, rating scales may be used to document each goal and intervention towards the lessening of acuity of the diagnoses. GIVE rating scales may be designed to address this need and give a common language to all clinical team members. This common language used by all members of a clinical team may be based on the descriptive terms that have long been used in the medical/surgical and rehabilitation fields.

Each goal and intervention may have an actual rating and an expected rating. The rating may be on a severity, function or efficacy scale, as explained in further detail below. The GIVE rating scales may be used in a dynamic fashion to follow and update a clinical care plan for each diagnosis of the patient. The standardization of the terms into a rating scale may allow a member of the clinical team to use the scales to assign an actual rating, an expected rating with a timeline to discuss the variances at preset intervals. Thus, the ratings may be used to allow the team to move efficiently and effectively toward the outcome.

The actual rating may be the rating of the patient at the current time the patient is assessed. The expected rating may be a forecasted rating projecting the outcome objective. The actual rating and the expected rating may be received 215 by the GIVE system.

The GIVE system may also receive 220 an expected time period. The expected time period may be the amount of time in which the expectation rating will be met for each goal and each intervention. In an embodiment, the expected time period will be the amount of time needed to reach the expected rating from the actual rating. The expected time period may be, but is not limited to, a set number of hours, days, weeks, or months. The expected time period may be used to reinforce an outcome timeline with a patient and may allow for discharge services to be planned and implemented accordingly. As discussed below, both the expected rating and the expected time period may be changed during the periodic review as the clinical staff has more observations, data and interactions with the individual patient.

In an embodiment, the expected rating and/or the expected time period may be determined based on historical data. In an embodiment, the expected rating and/or the expected time period may be based on what clinical endpoint the clinical professionals have experienced historically dealing with similar medical, surgical, or rehabilitative diagnoses. In an embodiment, the expected rating and/or the expected time period may be based on statistical evidence from medical literature. In an embodiment, the expected rating and/or the expected time period may be based on a compilation of data gathered within the individual health care team experience with the GIVE Analysis system.

Based on the actual rating and the expected ratings, a variance may be calculated 225 for each goal and intervention. A variance is the difference between the actual rating and the expected outcome rating. A variance greater than zero may represent a patient which has not yet reached their goals.

A report may be created 230 with the variances. The chart may be used to evaluate the effectiveness of the goals and/or interventions within a time period in a particular setting. In an embodiment, the report may only include variances greater than zero. The report may be used to focus the attention of the clinicians on those diagnoses. If the variance is greater than zero, the diagnosis has goals that have not been met and the interventions applied to reach these goals have not been completely effective.

In an embodiment, the clinician's explanation for the variance must be meaningful and measurable so that a possible solution can be proposed and discussed. If the variance remains unchanged for a prolonged period of time, the responsible clinician must defend the feasibility of the implementation in a reasonable time for that particular diagnosis. If it is deemed that the patient is unable to reach a certain predicted goal (i.e. the expectation was too high), the expected rating may be changed to reflect that decision along with the reason so that a zero variance may be reached.

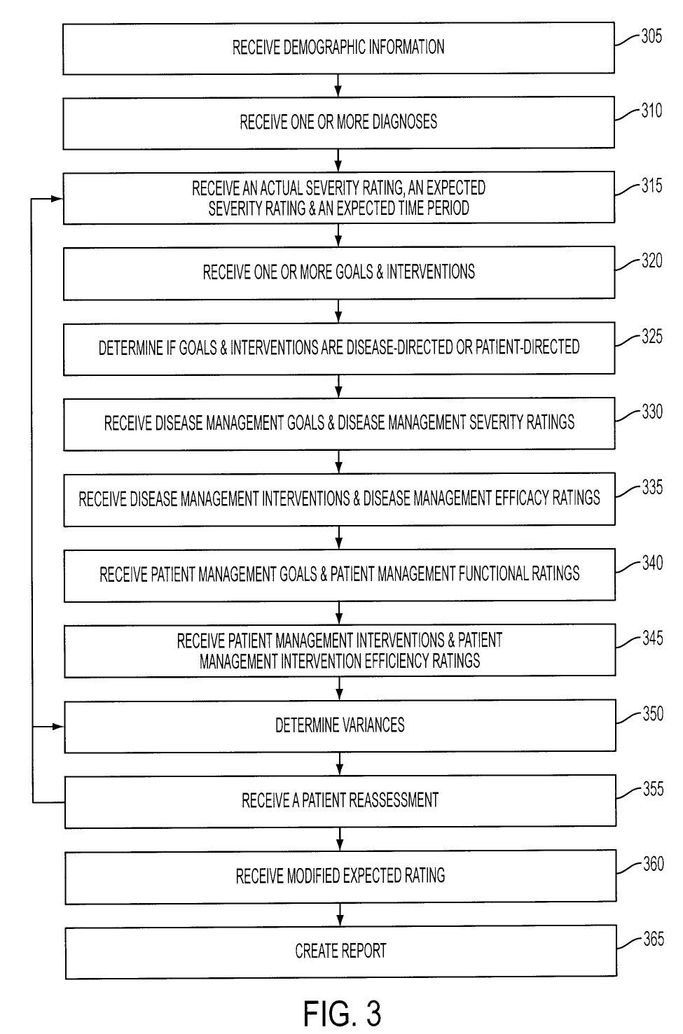

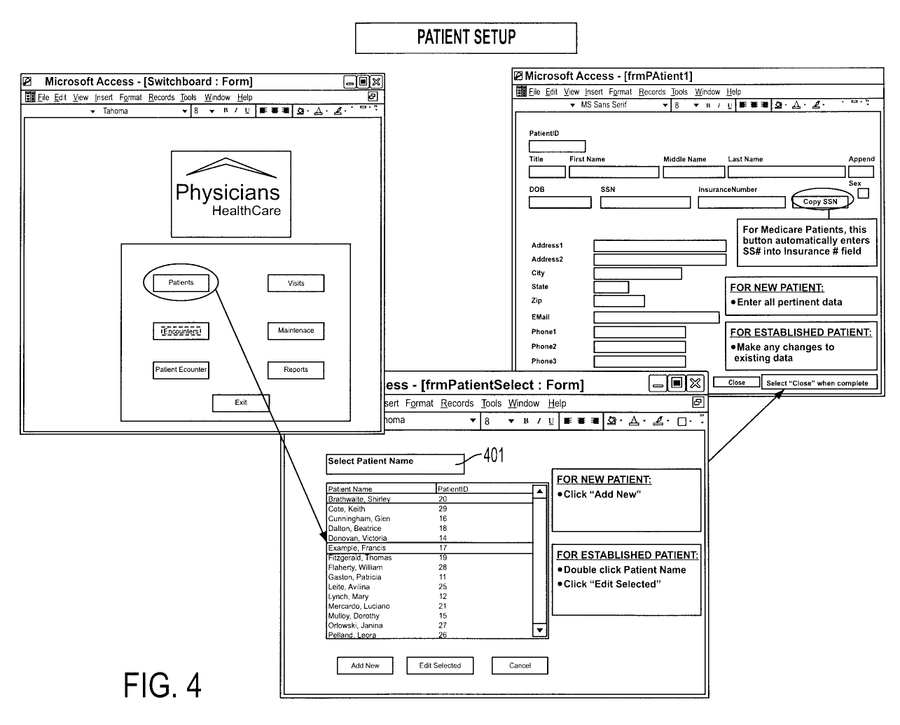

FIG. 3 depicts a detailed exemplary flowchart of the GIVE analysis according to an embodiment. In an embodiment, demographic information for each patient may be received 305. In an embodiment, a patient may receive a number or identification which is associated with the patient. FIG. 4 depicts an exemplary screen displaying the patient information according to an embodiment. As depicted in FIG. 4, a physician may enter a patient's name 401 and the information regarding the patient may be retrieved.

Referring also to FIG. 3, one or more diagnoses may be received for each patient 310. In an embodiment, the diagnoses may be received by the GIVE system in order of importance. In an alternate embodiment, the diagnoses may be received in any order and the GIVE system may order the diagnoses. For example, a diagnosis which carries greater potential of morbidity may be listed above a diagnosis which lesser potential of morbidity.

In an embodiment, an ICD-9 code may be associated with each diagnosis. Additionally, in an embodiment, medications and dosages may be associated with each diagnosis. The medications and dosages may be the medications and dosages currently taken by the patient.

In an embodiment, a severity scale may be used to rate the current acuity of the diagnosis. An actual severity rating, an expected severity rating, and an expected time period may be received for each diagnosis 315. Since the diagnosis is being actively treated, the rating is expected to improve depending on the success of the treatment. The dosages and types of medication can be altered throughout the treatment.

In an embodiment, the severity scale may be rated 0 to 4. A rating of 0 may represent that the patient is asymptomatic and/or no treatment is needed at this time. A rating of 1 may represent that symptoms are well controlled with the current treatment. A rating of 2 may represent that the symptoms are controlled with difficulty and/or continuous monitoring is needed. A rating of 3 may represent that the symptoms are poorly controlled and/or there is a frequent change in treatment/medications. A rating of 4 may represent that the symptoms are poorly controlled and there is a risk of re-hospitalization.

In an embodiment, each diagnosis has an actual severity rating and an expected severity rating. The actual severity rating may be the rating received for the patient at the actual time of assessment. If the patient is at a clinical facility, the actual severity rating may be the time when the patient is first admitted. If the patient is at home, the actual severity rating may be the time when the patient is first assessed. Each time a patient has a visit with one of the members of the clinical team, a new actual severity rating may be received by the GIVE system.

An expected severity rating may be the expected rating at the patient's completion of the goal. Additionally, an expected time period will be received by the GIVE system. The expected time period will be the amount of time needed to reach the expected rating from the actual rating.

In an embodiment, using the ICD-9 code for the diagnosis, one or more goals and/or one or more interventions may be received 320. The goals and/or interventions may be categorized 325 as either disease-directed or patient-directed. The goals and interventions may be categorized based on the patient and the clinical team members' role in the rehabilitation or treatment process. In an embodiment, the separation of goals and interventions into the patient-directed and disease-directed categories may allow the clinical team to reach goals with the patient while continuing to evaluate the effect of treatment on the disease process.

In an embodiment, the goal and intervention options within the patient-directed or disease directed categories may be predetermined. In an embodiment, there may be a limited amount of goal and intervention options in order to focus on the major issues for the clinical teams. The options may be limited to focus on issues that are important to the clinical member or specialist involved in patient care. In an embodiment, the GIVE system may provide the set of goals and/or intervention options based on the diagnosis reflected in the ICD-9 code. The GIVE system may receive the set of goals and/or intervention options chosen by the team member.

A disease-directed category may relate to the objective evaluation by the clinical team member as well as to the effectiveness of the disease management intervention in producing the expected outcome. The clinical team member may possess the expertise to conduct a physical examination of the patient, review history and clinical tests results and consider patient testimony. Using a severity and efficacy rating system, a clinical professional may make an assessment on a periodic basis as to the effectiveness of a disease-directed intervention in bringing about the disease-directed management goal.

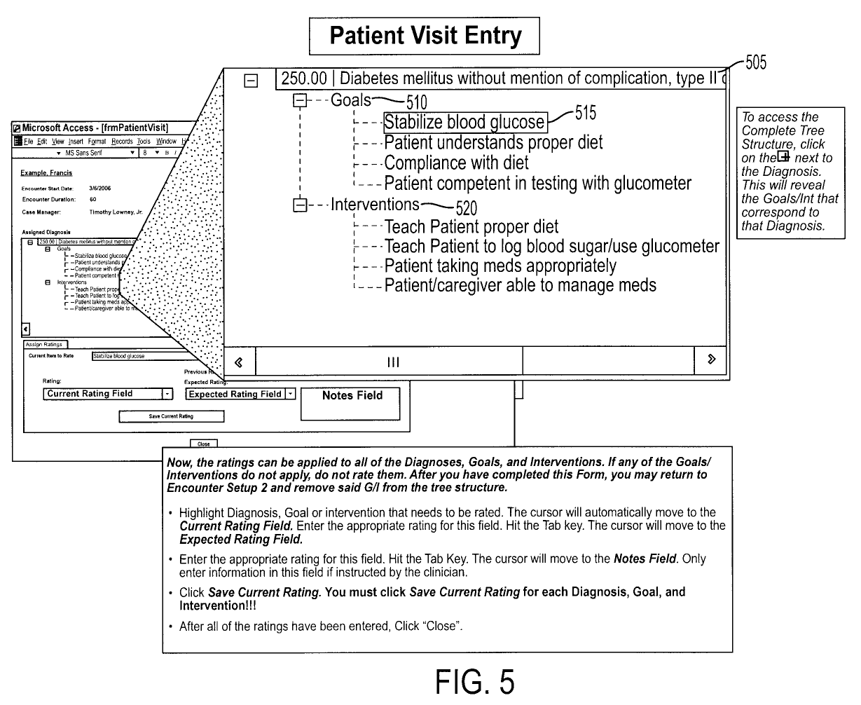

Referring also to FIG. 5, a chart illustrating the patient's goals and interventions according to an embodiment is shown. In FIG. 5, the disease is diabetes 505 which has an ICD-9 code of 250. Associated with that diagnosis is the disease management goal 510 of stabilizing blood glucose 515. Associated with the goals are interventions 520. A clinical team member may use his/her expertise to determine the effectiveness of an intervention on improving the signs and symptoms of the disease. T here may be multiple interventions for and multiple team members involved in several goals. Typically, as the rating of the intervention improves (from 5-0 on the efficacy scale), the goal rating and the diagnosis severity scale move in the same direction. This movement may ultimately lead to discharging the patient to a lower acuity setting or to independence.

In an embodiment, the expected intervention efficacy rating and the expected time period may be automatically determined based on historical data. In an embodiment, the expected intervention efficacy rating and the expected time period may be determined based on clinical team experience.

Referring back to FIG. 3, one or more disease management goals and associated disease management severity ratings may be received 330. The rating scale for each disease management goal may be measured on the severity scale discussed above. Associated with each disease management goal may be an actual disease management severity rating and an expected disease management severity rating. As with the actual disease severity rating and the expected disease severity rating, an actual disease management severity rating may be the severity of the disease management goal at the time a patient is assessed by a team member. The expected disease management severity rating may be the severity of the disease-directed management goal at the time that the patient leaves.

Each disease management goal may be associated with one or more disease management interventions. For example, the disease management goal may be, but is not limited to infection improvement and/or healing progression. The one or more disease management interventions may include, but are not limited to, therapy or medication.

A disease management intervention and an associated disease management intervention efficacy rating may be received 335. Each disease management intervention may be measured on an efficacy scale. In an embodiment, an efficacy scale may have ratings from 0 to 5. A rating of 0 may represent that the intervention is totally effective. A rating of 1 may represent that the intervention is moderately to maximally effective. A rating of 2 may represent that the intervention is minimally to moderately effective. A rating of 3 may represent that the intervention is minimally effective. A rating of 4 may represent that the intervention is not effective and a rating of 5 may represent that the intervention needs to be re-evaluated.

In an embodiment, the disease management intervention efficacy rating may be determined by a combination of both the patient and a clinical team member. In an embodiment, the clinical team member may be a primary care physician (PCP) and/or specialist. The patient may communicate the signs and symptoms of the disease and whether the process is being improved by the one or more disease management interventions. An actual disease intervention efficacy rating may be determined at the time of admittance. A new actual disease intervention efficacy rating may be determined each time the patient is assessed by the team member. An expected disease intervention efficacy rating may be the efficacy that it is hoped that the patient will achieve.

The patient-directed category may include one or more patient management goals and one or more patient interventions. The patient-directed category may refer to knowledge and skill transfer from a clinical team member to a patient and/or a patient's caregiver. The transfer of knowledge and skill may be a major role of the clinical team. In an embodiment, a patient normally requires teaching and re-teaching the skills that he/she will need in the short and long-term to manage their disease for the duration of the treatment period. In many cases, the patient will need this knowledge and skill set for on-going self-care of chronic diseases.

The clinical team constantly assesses the patient's ability or lack of ability to become independent. The GIVE system may receive a patient management goal and an associated patient management functional rating 340. The functional scale may be used to assess whether the transfer of knowledge and skills are successful in allowing self-care/independence. If self-care/independence is not attainable, the functional scale may estimate in what way and for how long a patient will be involved with professional care. In an embodiment, the ability for a patient to remain at home is a question requiring serious evaluation and documentation since the consequences are life-altering to the patient and their family.

In rehabilitative medicine, using the scale to judge the patient's ability to perform tasks and/or retain knowledge about the disease process is key to preparing the patient for self-care and reaching independence. In the functional scale, a rating of 0 may mean that the patient is independent. A rating of 1 may mean that the patient requires supervision and/or is modified independent. A rating of 2 may mean that the patient needs minimal/moderate assistance. A rating of 3 may meant that the patient needs moderate/maximum assist. 4 may mean that the patient needs maximum assistance and a rating of 5 may mean that the patient is totally dependent

For example, the functional scale may be used to assess the progress of the patient management goals relating to the knowledge and skills gained by the patient throughout the course of therapy. Therapy usually involves a transfer of knowledge or skills from the expert clinical team member to a patient or caregiver in the field. Since patient involvement is a key to success, it is important to clearly articulate to the patient their goals and the expectation of the clinical staff. The functional scale goes from totally dependent (5) to totally independent (0).

In FIG. 3, the GIVE system may receive a patient management intervention and an associated patient management intervention efficiency rating 345. The patient interventions may be rated on an efficiency scale as discussed above with the disease interventions. In an embodiment, the patient management intervention efficiency rating may be determined based on the knowledge gained by the patient from the team member.

After actual and expected ratings are received for the disease management goals, the disease management interventions, the patient management goals and the patient management interventions, one or more variances may be determined 350. A variance is the difference between the actual and expected rating on a particular date and time. A diagnosis that has a variance greater than zero has goals which have not been met and the interventions applied to reach the goals have not been completely effective.

Each variance may be explained, by a clinical team member, in a meaningful and measurable way so that a possible solution can be proposed and discussed. If the variance remains unchanged for a prolonged period of time, the responsible clinical team member must defend the feasibility of the implementation. If it is deemed that the patient is unable to reach a certain predicted goal (i.e. the expectation was too high), the expected outcome is changed to reflect that decision along with the reason so that a zero variance may be reached.

The GIVE system may receive a patient reassessment, i.e., a new actual rating, at a predetermined interval 355. The predetermined interval for patient assessment may be determined by the GIVE system. In an embodiment, the interval may be based on the severity of the rating. In an embodiment, the interval may be determined by the variance. Each time a patient is reassessed, a new set of actual ratings may be received 315 and a new variance may be determined 350 based on the new actual rating. The new variance may be compared with the previous variance to determine if the patient is reaching the expected rating.

In an embodiment, the interval of time to reassess the intervention may be determined by the potential morbidity of the diagnosis or symptom. For example, if the improvement in 0₂ sats is the goal based on chest physical therapy and actual medication, then it is not unreasonable to measure the effectiveness in hours rather than days, since the deterioration can be life threatening. In another case, the effectiveness of physical therapy on the gait improvement in a hip replacement patient is an issue of much less morbidity and a week may be a more appropriate time to expect the intervention to yield the desired effect.

In an embodiment, the expected outcome rating may be changed or modified when the patient is examined. The GIVE system may receive a modified expected rating 260.

A report may be created 265 by the GIVE system. In an embodiment, the report may include, but is not limited to, demographic information regarding a patient, the patient's medications with dosages, all diagnoses with actual and expected ratings (severity rating), all disease management goals with actual and expected ratings (severity rating), all patient management goals with actual and expected ratings (functional rating), and both disease and patient management interventions with actual and expected ratings (efficacy rating).

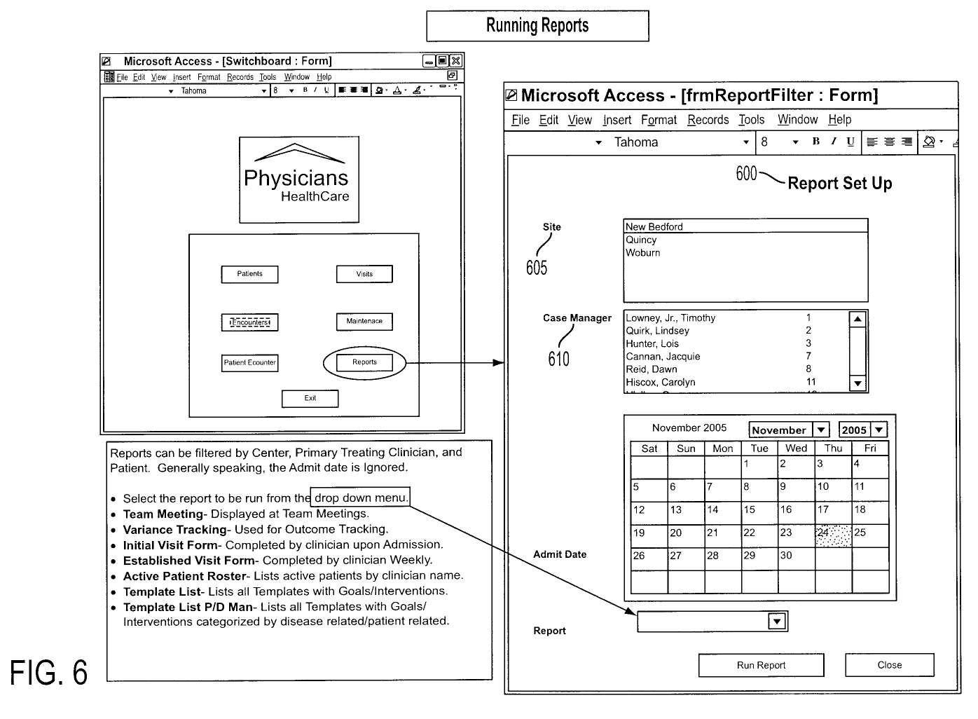

FIG. 6 depicts an illustration of setting up a report according to an embodiment. In FIG. 6, a report maybe generated using a report set-up window 600 from the GIVE system. In an embodiment, a report may be filtered by the site of a particular healthcare facility 605. In an embodiment, a report may be filtered by a case manager or a member of the clinical team 610. In an embodiment, the report may be filtered by the patient.

In an embodiment, the report may provide the most recent clinical evaluation, with the actual ratings from each assessment and the expected rating. The report may provide the variances after each actual rating. The report may allow the team to focus in those diagnoses, goals, and interventions with a variance. In an embodiment, the report only lists variances greater than zero. In an embodiment, the report may only list variances exceeding a predetermined variance amount. These high variances may be in a report because the actual rating may be significantly higher than the expected rating i.e. there is a higher potential morbidity in disease management goals or there is a significant educational need in patient management goals.

The report may be used in a team meeting to focus clinicians on those diagnoses that have a variance greater than zero. If the diagnosis variance is zero, this means that every goal and intervention has been met. If there are any remaining variances for goals and interventions related to the diagnosis, the variance for the diagnosis should not be zero. In an embodiment, as variances reach zero for goals and interventions, they will not appear on future reports, allowing the team to locus on only those unmet goals and interventions. Those goals with a zero variance may be reevaluated at a certain interval of time to ensure that the patient does not decompensate. If there is a variance, the diagnosis has goals that have not been met and the interventions applied to reach these goals have not been completely effective. The team member may need to provide an explanation for the variance that is meaningful and measurable so that a possible solution can be proposed and discussed.

In an embodiment, if the variance remains unchanged for a predetermined period of time the responsible clinician must defend the feasibility of the expected rating in a reasonable time for that particular diagnosis. If it is deemed that the patient is unable to reach the expected rating (i.e. the expectation was too high), the expected rating may be changed to reflect that decision along with the reason so that a zero variance is reached.

In an embodiment, the report may begin with the disease management goals with the highest variance in diagnosis and proceed to those with the lowest variance. The disease management interventions may continue to be appropriate or will be require adjustment or a completely new intervention.

In an embodiment, the report may then proceed to the patient management goals with the highest variance and proceed to those with the lowest variance. The patient management interventions may continue to be appropriate or will be require adjustment or a completely new intervention.

The variance may apply to the duration that is assigned to the particular goal or intervention. The difference in time between the date of the actual rating and the date of the expected rating is the variance of time.

In an embodiment, the report may have a high variance category. The high variance category may list the patients with a high variance. The high variance may be determined by comparing a patient's variance to a predetermined number. For example, the predetermined variance may have been six. This means that all patients that have a cumulative diagnosis variance of six or greater may be selected. For example, if Joe Shmoe has three diagnoses: Diabetes with a variance of 2, Hypertension with a variance of 2, and Abnormal Gait with a variance of 2, the total variance would be 6 so Joe would be shown in the high variance report.

In an embodiment, all patients that have an individual diagnosis variance of greater than zero and have not changed in three or more weeks may be on placed in the high variance category. The high variance category may be reviewed at team meetings until the team has designed goals and interventions which move the patient out of this category.

In an embodiment, the report may have a medium variance category. Patients that have a cumulative diagnosis variance of greater than 2 and less than 6 may be selected for the medium variance category. In an embodiment, cases may fall into two of the three categories depending on the status of the individual patient.

In an embodiment, the report may also determine if the variance becomes greater after a period of time. In an embodiment, if the variance increases over time, alternative treatment may be proposed based on historical data. In an embodiment, if the variance increases over time, then the members of the team may determine alternate interventions. By focusing on the unmet goals and ineffective interventions, the GIVE analysis is designed to easily evaluate these variances. The GIVE analysis documents the interventions that are not effective thus allowing the clinician to reevaluate and change an ineffective intervention or change the expectation of a goal that may be unattainable.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of achieving outcome objectives across a clinical setting, the method comprising:
receiving a diagnosis for a patient;
receiving one or more goals, wherein each goal has a goal actual rating, a goal expected rating and a goal expected time period;
receiving one or more interventions, wherein each intervention has an intervention actual rating, an intervention expected rating and an intervention expected time period;
determining a goal variance for each goal;
determining an intervention variance for each intervention;
creating a report based on the goal variance and the intervention variance.

2. The method of claim 1 wherein the report comprises each goal variance exceeding a predetermined threshold.

3. The method of claim 2 wherein the predetermined threshold is zero.

4. The method of claim 1 wherein the report comprises each intervention variance exceeding a predetermined threshold.

5. The method of claim 4 wherein the predetermined threshold is zero.

6. The method of claim 1 wherein the report categorizes the one or more goals into disease-directed goals and patient-directed goals.

7. The method of claim 1 wherein determining the goal variance comprises subtracting the goal expected rating from the goal actual rating.

8. The method of claim 1 wherein determining the intervention variance comprises subtracting the intervention expected rating from the intervention actual rating.

9. The method of claim 1 further comprising:
receiving demographic information for the patient

10. The method of claim 1 further comprising:
determining the goal expected rating based on prior data.

11. The method of claim 1 further comprising:
determining the goal expected time period based on prior data.

12. The method of claim 1 wherein receiving the one or more goals comprises receiving disease management goals wherein each disease management goal comprises an actual disease management severity rating and an expected disease management severity rating.

13. The method of claim 1 wherein receiving one or more goals comprises receiving one or more patient management goals, wherein each patient management goal comprises an actual patient management functionality rating and an expected patient management functionality rating.

14. The method of claim 1 wherein receiving one or more interventions comprises receiving one or more disease management interventions, wherein each disease management intervention comprises an actual disease management intervention efficiency rating and an expected disease management intervention efficiency rating.

15. The method of claim 1 wherein receiving one or more interventions comprises receiving one or more patient management interventions, wherein each patient management intervention comprises an actual patient management intervention efficiency rating and an expected patient management intervention efficiency rating.
